(19) United States
(12) Patent Application Publication
(10) Pub. No.: US 2008/0167790 A1
(43) Pub. Date: Jul. 10, 2008

(54) EGR Control Device For Internal Combustion Engine

(75) Inventors: Seijiro Kotooka, Kanagawa (JP); Susumu Kohketsu, Kanagawa (JP); Hitoshi Yokomura, Kanagawa (JP)

Correspondence Address: ROSSI, KIMMS & McDOWELL LLP., P.O. BOX 826, ASHBURN, VA, 20146-0826, US

(73) Assignee: MITSUBISHI FUSO TRUCK AND BUS CORPORATION, Kanagawa (JP)

(21) Appl. No.: 11/720,575

(22) PCT Filed: Nov. 28, 2005
(86) PCT No.: PCT/JP05/21774

§ 371 Date: Sep. 11, 2007

(30) Foreign Application Priority Data
Dec. 2, 2004 (JP) 2004-350020

(51) Int. Cl. F02D 45/00

(52) U.S. Cl. 701/108; 60/605.2; 60/611

(57) ABSTRACT

An EGR control device includes an EGR control means (44) which, when a large-amount EGR is requested, continuously controls an EGR valve (26) toward a fully open condition, and then continuously controls an intake throttle valve (12) toward a fully closed condition, and in a dead region where a change in the opening of the intake throttle valve only causes a small change in EGR quantity, the control means restricts a feedback control of the EGR quantity using the intake throttle valve and performs a feedback control of the EGR quantity using the EGR valve to compensate for the restriction of the feedback control using the intake throttle valve.

### TECHNICAL FIELD

This invention relates to an EGR (exhaust gas recirculation) control device for an internal combustion engine requiring recirculation of a large amount of exhaust gas.

### BACKGROUND ART

In this type of device, part of exhaust gas is brought back to an intake passage through a passage for EGR (EGR passage) and supplied to a combustion chamber. By feedback-controlling the recirculation amount of this exhaust gas (EGR quantity), establishment of a good combustion state and promotion of exhaust gas purification are intended.

In the conventional device, only an EGR valve for controlling the flow rate in the EGR passage was subjected to opening regulation. In recent internal combustion engines, however, operation with a large-amount EGR (high EGR rate) is sometimes required. Thus, in addition to the EGR valve, also an intake throttle valve for controlling the flow rate in the intake passage is subjected to opening regulation (see Japanese Unexamined Patent Publication No. 2001-152879). By this, for example a request for in-cylinder rich operation utilizing the emission of carbon monoxide due to imperfect combustion can be fulfilled. Further, suppression of NOx (nitrogen oxides) and warming of exhaust purification catalysts are intended.

In this known technique, the EGR valve and the intake throttle valve are both used and their respective openings are controlled continuously. In order to obtain a greater EGR quantity, the EGR valve is controlled toward a fully open condition, then with the EGR valve fixed in the fully open condition, the intake throttle valve is narrowed. In other words, control is switched from the EGR valve to the throttle valve, and the throttle valve is controlled toward a fully closed condition.

The inventors of this application know, however, that there exists a dead region between the fully open condition and the fully closed condition of the intake throttle valve. This dead region is produced due to reasons such that the change of pressure difference between the intake passage and the exhaust passage is small. More specifically, the EGR quantity does not follow the change of opening of the throttle valve at a constant rate, but comes to hardly change when the throttle valve comes near to the fully open condition. The dead region is the region where the change of the EGR quantity is still small, that is, the EGR quantity increases only a little in response to the change of the throttle valve opening.

The EGR quantity increases sharply when the throttle valve opening reaches, for example about 20 to 40% relative to the fully closed condition regarded as zero. The region where the change of the EGR quantity is great, that is, the EGR quantity increases sharply like this is called a responsive region. Meanwhile, the EGR quantity follows the change of opening of the EGR valve linearly, as compared with the change of opening of the throttle valve.

Thus, there is a problem that even if control is switched from the EGR valve to the throttle valve in order to obtain a greater EGR quantity as in the above-mentioned operation with a large-amount EGR, since the change of the EGR quantity is small in the above-mentioned dead region, the desired EGR quantity is not obtained even at the time when the throttle valve almost reaches the fully closed condition.

This problem can be solved by setting the throttle valve manipulation quantity, or the throttle valve control gain to a greater value in the dead region. In this case, however, matching of the control gain through the dead region and the responsive region is required, and since such matching is difficult, the device may not be able to be simplified. Thus, some measure needs to be taken in connection with switch of control from the EGR valve to the throttle valve, but the above-mentioned known technique gives no special consideration to this.

### DISCLOSURE OF THE INVENTION

This invention has been made to solve the problem like this, and the primary object thereof is to provide an EGR control device for an internal combustion engine capable of providing a desired EGR quantity and being simplified.

In order to achieve the above object, an EGR control device for an internal combustion engine according to the present invention comprises an intake throttle valve provided in an intake passage of the internal combustion engine and an EGR valve provided in an EGR passage connecting the intake passage and an exhaust passage, and is designed to feedback-control EGR quantity by continuously controlling the opening of the EGR valve and the opening of the intake throttle valve, wherein the EGR control device includes an EGR control means which, when a large-amount EGR is requested, continuously controls the EGR valve toward a fully open condition, and then continuously controls the intake throttle valve toward a fully closed condition, and in a dead region where a change in the opening of the intake throttle valve only causes a small change in EGR quantity, the control means restricts a feedback control of the EGR quantity using the intake throttle valve and performs a feedback control of the EGR quantity using the EGR valve to compensate for the restriction of the feedback control using the intake throttle valve.

As stated above, between the fully open condition and the fully closed condition of the intake throttle valve, there exists a dead region where the change of the EGR quantity is still small, so that the desired EGR quantity cannot be achieved. In this case, however, the control means restricts a feedback control of the EGR quantity using the intake throttle valve and performs a feedback control of the EGR quantity using the EGR valve to compensate for this restriction. Thus, in spite of the existence of the dead region, the desired EGR quantity can be obtained.

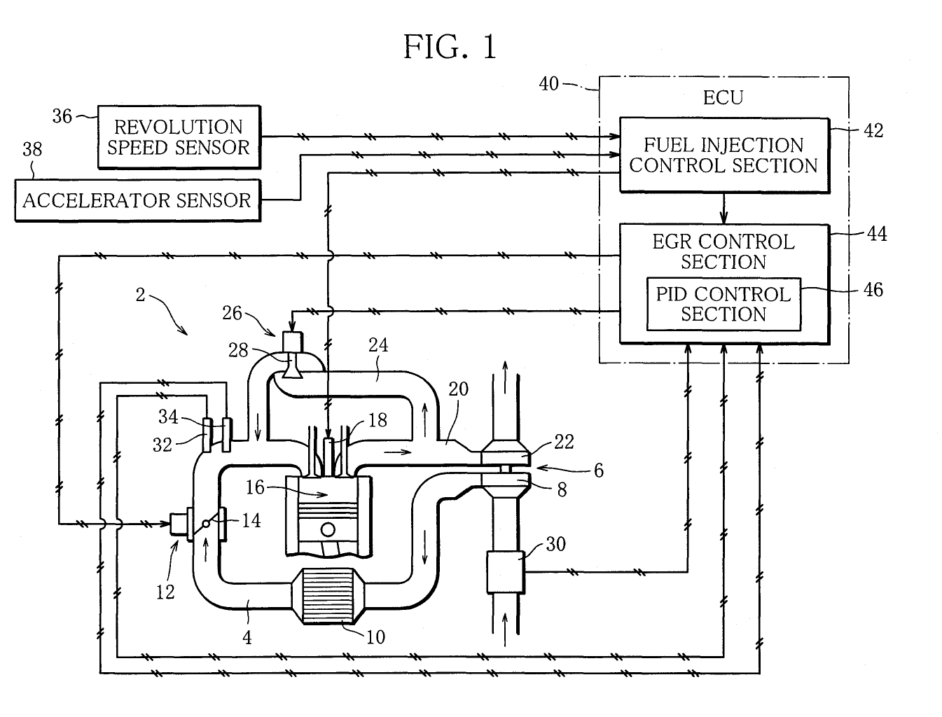

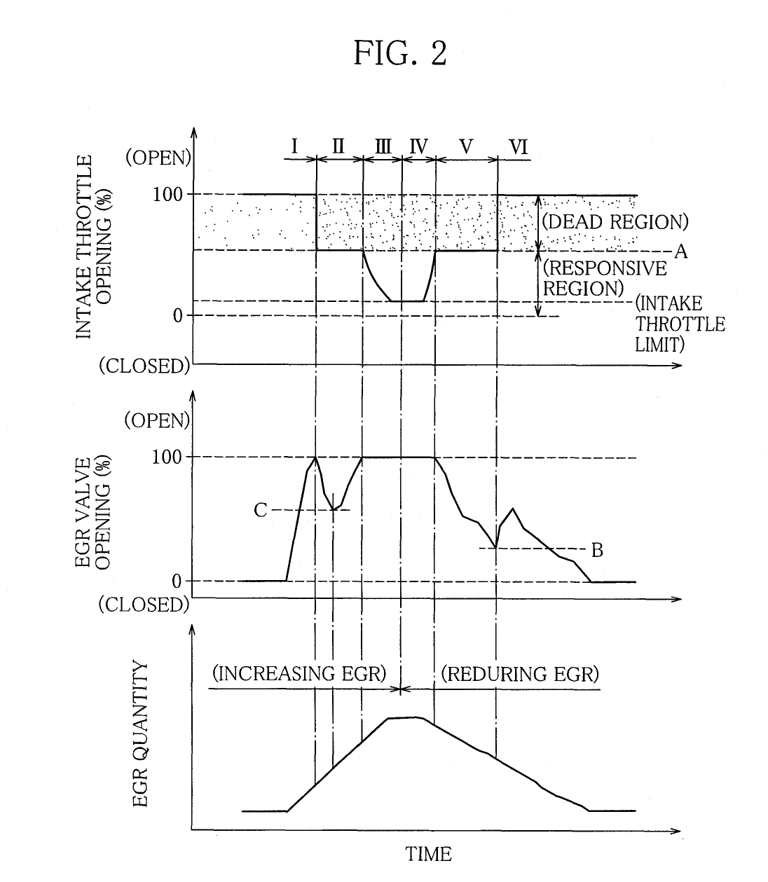

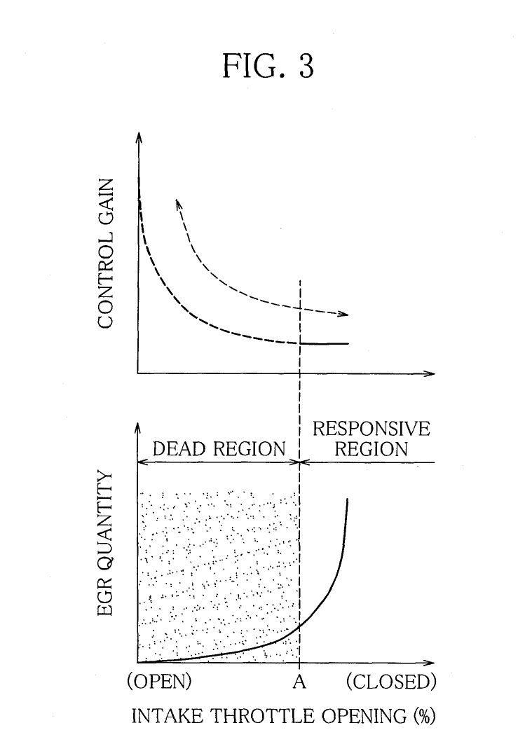

### BRIEF DESCRIPTION OF THE DRAWINGS

[FIG. 1] A diagram showing the entire structure of EGR control device according to an embodiment of the present invention.

[FIG. 2] A timing chart regarding switch between an EGR valve and an intake throttle valve in the EGR control device of FIG. 1.

[FIG. 3] A diagram showing the relation between control gain and intake throttle valve opening, and relation between EGR quantity characteristic and intake throttle valve opening in the EGR control device of FIG. 1.

### BEST MODE OF CARRYING OUT THE INVENTION

Referring to the drawings, an embodiment of the present invention will be described below.

FIG. 1 shows an EGR control device embodied for a diesel engine. As shown in this drawing, a turbocharger 6 is provided in an intake passage 4 of an engine 2. Air taken in through an air cleaner (not shown) is introduced into a combustion chamber 16 through an intercooler 10 after being pressurized by a compressor 8.

In the passage 4, at an appropriate position, an intake throttle valve 12 is provided. The throttle valve 12 has a butterfly valve disc 14 driven by a brushed motor. By opening and closing the valve disc 14, the flow rate of intake air and also the recirculation amount of exhaust gas (EGR quantity) are controlled as described later. Thus, in the throttle valve 12 of this embodiment, a current is supplied to a coil for generating a magnetic field by using brushes.

To an exhaust passage 20 of the engine 2, a turbine 22 coaxially connected with the compressor 8 is provided. The compressor 8 and the turbine 22 are driven to rotate by exhaust gas produced by combustion.

The passage 4 and the passage 20 are connected by an EGR passage 24. In this passage 24, at an appropriate position, an EGR valve 26 is provided. The valve 26 has a poppet valve plug 28 driven by a brushless motor. By opening and closing the valve plug 28, the EGR quantity is controlled. Thus, in the EGR valve 12 of this embodiment, a current is supplied to a coil without using brushes.

In a vehicle compartment, an ECU 40 including an input-output device, memory (ROM, RAM, BURAM, etc.) for storing control programs, maps, etc., a central processing unit (CPU), timer counters, etc., which are not shown, is installed. The ECU 40 performs a comprehensive control of the engine 2, including a continuous control of the opening of the throttle valve 12 and of the EGR valve 26.

To the input of the ECU 40, various sensors such as an air flow sensor 30, an intake pressure sensor 32, an intake temperature sensor 34, a revolution speed sensor 36, and an accelerator sensor 38 are connected. The sensor 30 supplies a voltage corresponding to the amount of air taken in by the engine 2, the sensor 32 detects the intake pressure, and the sensor 34 detects the intake temperature. The sensor 36 detects the revolution speed of the engine 2, and the sensor 38 detects the amount of manipulation of the accelerator by the driver. Meanwhile, to the output of the ECU 40, the above-mentioned throttle valve 12 and EGR valve 26 and other various devices such as fuel injection valves 18 are connected.

The ECU 40 has an injection control section 42 which controls the fuel injection valves 18 and an EGR control section (EGR control means) 44 which controls the throttle valve 12 and the EGR valve 26. When a greater EGR quantity, or in other words, a large-amount EGR is requested, the ECU 40 feedback-controls the EGR quantity by continuously controlling the opening of the valve disc 14 of the throttle valve 12 and the opening of the valve plug 28 of the EGR valve 26 to achieve a target air excess ratio.

Specifically, the control section 42 sets a fuel injection quantity etc. on the basis of a revolution speed supplied from the sensor 36 and an accelerator manipulation quantity supplied from sensor 38, for example, and operates the engine 2 by drive-controlling the fuel injection valves 18 on the basis of those set values.

The control section 44 sets a target air excess ratio from the map stored in the memory, on the basis of the revolution speed and accelerator manipulation quantity supplied, and calculates a target EGR quantity. The control section 44 also calculates an actual EGR quantity by calculating an actual air excess ratio from a fresh air quantity per second supplied from the sensor 30, a fuel injection quantity per second, a stoichiometric air-flow ratio and the amount of air contained in exhaust gas recirculated through the passage 24. The amount of air contained in exhaust gas recirculated through the passage 24 can be obtained from the EGR quantity per second and the actual air excess ratio calculated last time, where the EGR quantity per second is obtained by subtracting the above-mentioned fresh air quantity per second from the total intake quantity per second. The total intake quantity per second is the amount of total intake entering the combustion chamber 16 per second, and obtained, for example on the basis of an intake pressure supplied from the sensor 32 and an intake temperature supplied from the sensor 34.

In the present embodiment, next, the difference between the target EGR quantity and the actual EGR quantity, each calculated in the above-described way, is fed back. Then an instruction value is obtained using a control gain set by a PID control section 46, and on the basis of this instruction value, the amount of turn of the valve disc 14 of the throttle valve 12 and the amount of lift of the valve plug 28 of the EGR valve 26 are controlled continuously. Consequently, the requested EGR quantity is obtained, so that the air excess ratio approaches the target.

When a greater EGR quantity is requested, the control section 44 controls the EGR valve 26 toward the fully open condition, and then, a switch of control from the EGR valve 26 to the throttle valve 12 is performed. Here, in the process in which the throttle valve 12 shifts from the fully open condition toward the fully closed condition, there is a dead region, namely the region where the change of the EGR quantity is still small. Thus, in this dead region, the control section 44 restricts the control of the EGR quantity using the throttle valve 12 and performs an open-loop control, and in order to compensate for this restriction, performs a feedback control of the EGR quantity using the EGR valve 26.

More specifically, when a greater EGR quantity is requested and the EGR valve 26 reaches the fully open condition (100%) in response to this request, the control section 44 determines that the EGR quantity is still insufficient. As seen from FIG. 2, at this time, however, the throttle valve 12 is in the fully open condition (100%), which is in the dead region for the throttle valve 12 (see period I). Thus, the continuous control of the opening of the throttle valve 12 is restricted, that is, the throttle valve 12 is instantly narrowed up to a predetermined opening A (see period I). The predetermined opening A is an opening which has little influence on the EGR, for example an opening of about 20 to 40% relative to the fully closed condition (0%). The throttle valve 12 is thus instantly transferred from the dead region to the responsive region (region in which the change of the EGR quantity responsive to the change of the opening of the throttle valve 12 is great), so that the dead region is avoided.

Then, the throttle valve 12 is fixed at the predetermined opening A (see period II). By instantly narrowing the throttle valve 12 from the fully open condition (100%) and fixing it at the predetermined opening like this, the situation in which the exhaust gas can be easily introduced into the intake passage 4 is created. This is because the dead region is avoided, even though the action of the throttle valve 12 is forced to be discontinuous, unlike the case of the continuous control. Along with this operation, a continuous control of the opening of the EGR valve 26 is performed. Specifically, the EGR valve 26 is gradually closed from the fully open condition (100%) to a predetermined opening C (see period II). This is to compensate for the restriction of the feedback control of the EGR quantity using the throttle valve 12, or in other words, to suppress an instant increase in EGR quantity caused by narrowing the throttle valve 12 up to the predetermined opening A. Consequently, the EGR quantity increases in the manner that the rate of increase at the time when the EGR valve 26 reaches the predetermined opening C is the same as that at the time when the EGR valve 26 reached the fully open condition (100%) for the first time.

After this, the EGR valve 26 is gradually opened again toward the fully open condition (100%) (see period II). By this, the suppression of the EGR quantity by fixing the throttle valve at the predetermined opening A is further compensated for, and the EGR quantity is increased smoothly, at the same rate of increase. These periods I and II are periods of feedback control of the EGR quantity using the EGR valve 26.

When the EGR valve 26 reaches the fully open condition (100%) again, the continuous control of the opening of the EGR valve 26 is restricted, or in other words, the EGR valve 26 is fixed in the fully open condition (100%) (see period III). Along with this operation, a continuous control of the opening of the throttle valve 12 is performed, and the throttle valve 12 is gradually narrowed toward the fully closed condition (0%), up to an intake throttle limit value (see period III). This limit value is a value for preventing misfire. The EGR quantity is further increased at the same rate of increase, and when it reaches a desired EGR quantity, the operation for increasing the EGR quantity is finished. This period III is a period of feedback control of the EGR quantity using the throttle valve 12.

Meanwhile, when a reduction of the EGR quantity is requested, the control section 44 performs a continuous control of the opening of the throttle valve 12 while holding the EGR valve 26 in the fully open condition (100%), thereby gradually opening the throttle valve 12 toward the fully open condition (100%), up to the predetermined opening A (see period IV). By this, the EGR quantity is reduced. This period IV is a period of feedback control of the EGR quantity using the throttle valve 12.

Then, when the throttle valve reaches this predetermined opening A again, the continuous control of the opening of the throttle valve 12 is restricted, or in other words, the throttle valve 12 is fixed at the predetermined opening A (see period V). Along with this operation, a continuous control of the EGR valve 26 is performed. Specifically, the EGR valve 26 is gradually closed from the fully open condition (100%) up to a predetermined opening B (another predetermined opening) (see period V). By this, the EGR quantity is reduced smoothly at the same rate of reduction.

The predetermined opening B can be the fully closed condition (0%). However, if the predetermined opening B is an opening greater than the fully closed condition, a sharp decrease in pressure on the downstream side of the throttle valve 12 caused by supplying exhaust gas to the combustion chamber 16 is prevented, so that torque variations are suppressed. It is to be noted that this predetermined opening B is smaller than the predetermined opening C in period II. This is because if the predetermined opening B is greater than the predetermined opening C, the throttle valve 12 returns to the fully open condition (100%) when the EGR valve 26 reaches this opening as described below, so that a switch of control between the throttle valve 12 and the EGR valve 26 occurs frequently.

Then, when the EGR valve 26 reaches the predetermined opening B, the throttle valve 12 is instantly opened up to the fully open condition (100%) (see period V). This is because in order to further reduce the EGR quantity, the throttle valve 12 needs to be set at an opening greater than the predetermined opening A, but the openings greater than the predetermined opening A are in the dead region for the throttle valve 12.

Along with this operation, the EGR valve 26 is gradually opened from the predetermined opening B (see period VI). This is to compensate for the restriction of the feedback control of the EGR quantity using the throttle valve 12, or in other words, to suppress an instant reduction in EGR quantity caused by opening the throttle valve 12 up to the fully open condition (100%). Consequently, the EGR quantity is reduced at the same rate of reduction also after the EGR valve 26 reaches the predetermined opening B. After this, the EGR valve 26 is gradually closed toward the fully closed condition (0%) (see period VI). By this, the EGR quantity is reduced smoothly, at the same rate of reduction, and when the EGR quantity reaches the desired quantity, the operation for reducing the EGR quantity is finished. These periods V and VI are periods of feedback control of the EGR quantity using the EGR valve 26.

As understood from the above, the point of the present embodiment is to perform a feedback control of the EGR quantity, reducing the actions of the intake throttle valve 12 driven by the brushed motor while increasing the actions of the EGR valve 26 driven by the brushless motor.

In the present embodiment, the dead region is avoided by the control section 44 instantly closing or opening the throttle valve 12. In particular, when the EGR quantity is increased, by closing the throttle valve 12 instantly from the fully open condition up to the predetermined opening A, the throttle valve 12 is brought into the responsive region, so that the situation in which the exhaust gas can be more easily introduced to the intake passage 4 is created. Thus, by performing a feedback control of the EGR quantity using the EGR valve 26 from this time, the operation of the throttle valve 12 for which a continuous control of the opening is not performed can be compensated for. Thus, in spite of the existence of the dead region, the desired EGR quantity can be obtained before the throttle valve 12 reaches the above-mentioned throttle limit value. This enables construction of a high-accuracy, high-responsive system.

The opening of the throttle valve 12 is fixed in periods II and V, and the feedback control of the EGR quantity using the throttle valve 12 is performed only in periods III and IV. Thus, as compared with the period of feedback control of the EGR quantity using the intake throttle valve in the conventional device, the period of feedback control of the EGR quantity using the throttle valve 12 is shorter by the length corresponding to periods II and V. Consequently, the opening and closing actions of the throttle valve 12 are reduced, so that the durability of the throttle valve 12 improves. In particular, when the throttle valve 12 is driven by the brushed motor as in the present embodiment, the wear of sliding surfaces is prominently suppressed, so that the durability improves to a great degree.

Further, hysteresis is provided between the way of bringing the throttle valve 12 from the fully open condition (100%) to the predetermined opening A in the process of increasing the EGR quantity in the dead region and the way of bringing the throttle valve 12 from the predetermined opening A to the fully open condition (100%) in the process of reducing the EGR quantity in the dead region. Specifically, in the process of increasing the EGR quantity, when the EGR valve 26 reaches the fully open condition (100%) for the first time, the above operation is performed upon this full opening as a threshold. Meanwhile, in the process of reducing the EGR quantity, when the EGR valve 26 reaches the predetermined opening B, the above operation is performed upon this opening as a threshold. Thus, different thresholds for switch to the control for avoiding the dead region are set for the process of increasing the EGR quantity and for the process of reducing the EGR quantity. By this, even if the opening of the EGR valve 26 continues to vary so that the opening of the throttle valve 12 is in the dead region, frequent switches between the control for fixing the throttle valve 12 in the fully open condition (100%) and the control for fixing the throttle valve 12 at the predetermined opening A (about 20 to 40%) can be avoided. Consequently, the flipping of the throttle valve 12 is suppressed. This also contributes to improving the durability of the throttle valve 12.

Further, since the dead region is avoided by instantly closing or opening the throttle valve 12, the control gain for the throttle valve 12 does not need to be set for this dead region. This allows the device to be simplified.

Specifically, as shown in FIG. 3, when the feedback control of the EGR quantity using the EGR valve 26 is restricted, the control gain for the throttle valve 12 can be set only considering the responsive region on the right side of the predetermined opening A (as indicated by the solid line in the drawing). The dead region does not need setting of the control gain (as indicated by the dashed line in the drawing). Further, in the responsive region, the control gain does not need to take great values.

Further, matching of the control gain through the dead region and the responsive region (as indicated by the dashed line with arrows in the drawing) is not needed. This allows the device to be more simplified.

In the above, one embodiment of the present invention has been described. The present invention is however not limited to the embodiment described above.

For example, although in the described embodiment, the EGR control section 44 calculates the actual EGR quantity from values supplied from the sensor 30, etc., the feedback control of the EGR quantity can be performed using the detected value of actual EGR quantity, in place of the calculated value.

Further, in the described embodiment, the feedback control of the EGR quantity is performed by continuously controlling the throttle valve 12 and the EGR valve 26 to achieve the target air excess ratio. The present invention is however not limited to this example. The feedback control of the EGR quantity can be performed by continuously controlling the throttle valve 12 and the EGR valve 26 to achieve any value that reflects the object of the EGR quantity control, for example, the target intake O₂ concentration.

Further, although the above-described embodiment is an EGR control device for the diesel engine 2, the present invention can be embodied, for example, as an EGR control device for a gasoline engine. The EGR control device of this type can be achieved by not considering the amount of air contained in the exhaust gas in the EGR passage 24, etc.

1. An EGR control device for an internal combustion engine, comprising
an intake throttle valve provided in an intake passage of the internal combustion engine and an EGR valve provided in an EGR passage connecting the intake passage and an exhaust passage, and designed to feedback-control EGR quantity by continuously controlling the opening of the EGR valve and the opening of the intake throttle valve, wherein
the EGR control device includes an EGR control means which, when a large-amount EGR is requested, continuously controls the EGR valve toward a fully open condition, and then continuously controls the intake throttle valve toward a fully closed condition, and
in a dead region where a change in the opening of the intake throttle valve only causes a small change in EGR quantity, said control means restricts a feedback control of the EGR quantity using the intake throttle valve and performs a feedback control of the EGR quantity using the EGR valve to compensate for the restriction of the feedback control using the intake throttle valve.

2. The EGR control device for an internal combustion engine according to claim 1, wherein
in said dead region, said control means instantly narrows the intake throttle valve from the fully open condition up to a predetermined opening for transferring the intake throttle valve to a responsive region where a change in the opening of the intake throttle valve causes a great change in EGR quantity, and fixes the intake throttle valve at said predetermined opening and performs the feedback control of the EGR quantity using the EGR valve.

3. The EGR control device for an internal combustion engine according to claim 2, wherein
after the intake throttle valve is narrowed to said predetermined opening, when the EGR valve reaches the fully open condition, said control means fixes the EGR valve in the fully open condition and performs the feedback control of the EGR quantity using the intake throttle valve.

4. The EGR control device for an internal combustion engine according to claim 3, wherein
when the intake throttle valve reaches said predetermined opening again during the feedback control using the intake throttle valve, said control means fixes the intake throttle valve at said predetermined opening and performs the feedback control of the EGR quantity using the EGR valve.

5. The EGR control device for an internal combustion engine according to claim 4, wherein
when the EGR valve reaches another predetermined opening greater than the fully closed condition during the feedback control using the EGR valve, said control means instantly opens the intake throttle valve from said predetermined opening up to the fully open condition, and fixes the intake throttle valve in the fully open condition and performs the feedback control of the EGR quantity using the EGR valve.

6. The EGR control device for an internal combustion engine according to claim 5, wherein
hysteresis is provided between the way in which said control means shifts the intake throttle valve from the fully open condition to said predetermined opening for increasing the EGR quantity in said dead region, and the way in which said control means shifts the intake throttle valve from said predetermined opening to the fully open position for reducing the EGR quantity in said dead region, by setting different thresholds for switch for avoiding said dead region.
